(19) United States
(12) Patent Application Publication
(10) Pub. No.: US 2006/0171087 A1
(43) Pub. Date: Aug. 3, 2006

(54) High-voltage protection device of coil driving device

(75) Inventor: Kevin Chen, Taipei (TW)

Correspondence Address: HDSL, 4331 STEVENS BATTLE LANE, FAIRFAX, VA, 22033, US

(73) Assignee: Fortune Semiconductor Corporation

(21) Appl. No.: 11/045,267

(22) Filed: Jan. 31, 2005

(51) Int. Cl. H02H 9/04

(52) U.S. Cl. 361/91.1

(57) ABSTRACT

A high voltage protection device applied to a coil driving device of a DC fan and motor. The coil driving device is connected to the high voltage protection device that has an activation control unit connected to the coil driving device, a logic operation unit that has two input terminals connected to a protection activation signal source and the activation control unit, a high voltage protection unit connected to an output terminal of the logic operation unit and the driving device. When the voltage of the coil driving device is higher than a predetermined value, the potential of a digital signal output is adjusted high and input to the logic operation unit. By logic operation performed on the input digital signal and another digital signal obtained from a protection signal source, a signal is generated to activate the high-voltage protection device, and the operation voltage of coil driving device can return to normal value.

### BACKGROUND OF THE INVENTION

1. Field of Invention

The present invention relates in general to a high-voltage protection device, and more particularly, to an activation control unit and a logic operation unit connected to a driving device of a fan or a motor. The high-voltage protection device uses an activation mechanism that controls the high-voltage protection unit by a digital signal. The operation voltage is controlled at a normal value to limit the excessively high voltage generated by transient counter electromotive force.

2. Related Art

Currently, in the brushless DC fan or DC motor, high voltage is constantly generated by counter electromotive force during the polarity exchange of the coil power source. The high voltage frequently raises the operation voltage of the driving device and affects the activation of the fan or motor. Therefore, a voltage protection design is required for the brushless DC fan or motor to restrict the high voltage caused by the counter electromotive force, so as to protect the coil driving device.

Taiwanese Patent No. 511818 discloses a coil driving device having power source tracking and high-voltage protection function. In this device, a set of protection devices are interposed between each coil driving device and the pulse generator that controls the operation of the driving device. The protection device has one terminal connected to ground. The protection device is composed of a voltage limiting device, an amplifier, and a switch. The total limitation of the voltage limiting devices is the sum of a predetermined limit and the voltage of the power source. The voltage limiting device has a reference device connected to the reference voltage input terminal of an amplifier to provide the limited voltage value. The amplifier has a positive input terminal connected to the source terminal of a transistor built in the corresponding driving device and the reference input terminal connected to the power source and the reference device. The switch is connected to the output terminal of the amplifier and the gate terminal of the transistor. When the coil switches the polarity to cause a counter-electromotive voltage higher than the total voltage limitation, the voltage limiting device is connected to the coil and the power source form, so as to dissipate the counter electromotive voltage to ground. This device uses the amplifier for an analog signal comparison. Therefore, the volume of the chip design is large, and the cost is high. In addition, the response speed of the analog signal is slower than that of the digital signal. Moreover, voltage of the reference voltage device has to be larger than the voltage of the power source, this increases the complexity and cost.

### SUMMARY OF THE INVENTION

A redesign of the high-voltage protection device of a DC fan or motor is provided. The driving device of the fan or motor is connected to an activation control unit and a logic operation unit. An activation mechanism that uses a digital signal to control a voltage protection unit is employed to adjust the operation voltage of the coil driving device back to a normal range. The design as provided can be fabricated with reduced chip area and cost. In addition, the digital signal control has faster response speed, and the complex device for the reference voltage is not required.

Accordingly, the high-voltage protection device of the present invention comprises an activation control unit, a logic operation unit, a protection activation signal source, and a high-voltage protection unit connected to an output terminal of the logic operation unit and the coil driving device.

The activation control unit is connected to the coil driving device. The logic operation unit is connected to the activation control unit, and the logic operation unit has a first input terminal connected to the activation control unit to obtain a first digital signal therefrom and a second input terminal. The protection activation signal source provides a second digital signal to the second input terminal. The high-voltage protection unit is connected to an output terminal of the logic operation unit and the coil driving device. When an operation voltage of the coil driving device is higher than a predetermined value, the activation control unit inputs the first digital signal to the first terminal, and the logic operation unit performs calculation on the first and the second digital signals to output a protection activation signal for activating the high-voltage protection device.

### BRIEF DESCRIPTION OF THE DRAWINGS

The present invention will become more fully understood from the detailed description given hereinbelow illustration only, and thus are not limitative of the present invention, and wherein:

FIG. 1 shows a block diagram of a high-voltage protection device provided in one embodiment of the present invention; and

FIG. 2 is a circuit diagram of the voltage-protection device as shown in FIG. 1.

### DETAILED DESCRIPTION OF THE INVENTION

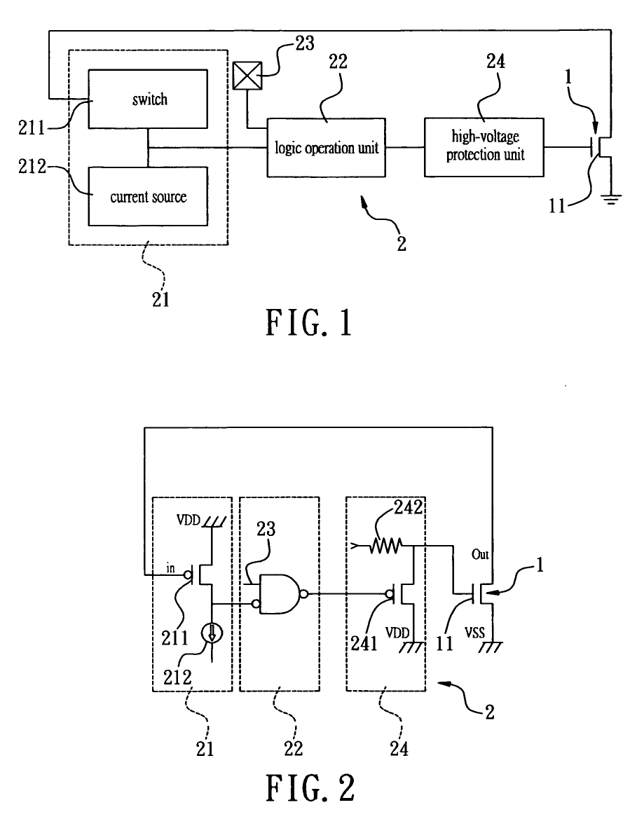

Referring to FIGS. 1 and 2, an embodiment of a high-voltage protection device applied to a coil driving device 1 of a DC fan or motor is illustrated. The coil driving device 1 includes at least one first switch 11 connected to a lowest-voltage source and a high-voltage protection device 2. The high-voltage protection device 2 includes an activation control unit 21, a logic operation unit 22, a protection activation signal source 23 and a high-voltage protection unit 24. When the operation voltage of the coil driving device 1 is larger than a predetermined value, the voltage level of the first digital signal input to the logic operation device 22 is changed by the activation control unit 21. A second digital input at a second voltage level is input from the protection activation signal source 23 to the logic operation unit 22. By the calculation of the logic operation unit 22, a digital signal is output from the logic operation unit 22 to control the activation of the high-voltage protection unit 24. Thereby, the first switch 11 of the coil driving device 1 is activated to conduct the coil driving device with the lowest power source, so as to adjust the operation voltage of the coil driving device back to normal.

The activation control unit 21 includes a second switch 211 and a current source 212. Preferably, the second switch 211 includes a transistor Q1 that has a first terminal (drain) connected to a current source 212 to form the first input terminal of the logic operation unit 22, a second terminal (gate) connected to the coil driving device 1, and a ground terminal (source) connected to a highest-voltage source. The voltage of the first terminal is lower than the operation voltage. Thereby, a first input terminal of the logic operation unit 22 is formed. When the operation voltage of the coil driving device 1 is higher than the voltage required for switch operation required by the second switch 211, the second switch is switched off, and a high-to-low signal is generated at the input terminal of the logic operation unit 22.

The logic operation unit 22 includes a NAND gate which has two digital signal input terminals. The first input terminal is connected to the current source 212 and the first terminal (drain) of the activation control unit 22. Thereby, logic high “1” digital signal or logic low “0” digital signal can be generated as the first digital signal input required by the calculation executed by the logic operation unit 22, the second input terminal is connected to a protection activation signal source 23 for inputting a second digital signal required by the calculation executed by the logic operation unit 22. Thereby, the logic operation unit 22 can perform NAND gate logic operation upon the first and second digital signals to generate “high” or “low” signal, so as to control the activation of the voltage protection unit 24 for adjusting operation voltage of the coil driving device 1.

The protection activation signal source 23 includes a digital signal of which the input condition can be adjusted externally. The normal input of the digital signal includes logic high “1” signal.

The voltage protection unit 24 includes a third switch 241 and a resistor 242 connected to each other. The third switch 241 includes a transistor Q2, for example. The first terminal (gate) of the transistor Q2 is connected to the output terminal of the logic operation unit 22 to obtain the activation control signal, the second terminal (drain) of the transistor Q2 is connected to the resistor 242, and the gate of the first switch 11 in the coil driving device 1, and the third terminal (source) of the transistor Q2 is configured as a ground terminal connected to a second highest voltage source.

The high-voltage protection device 2 provided as above is connected to the coil driving device I of a DC fan or motor. When the coil driving device 1 is working under a normal operation voltage which is not higher than the predetermined value, the second switch 211, that is, the transistor Q1 of the activation control unit 21 is in activated conducting state. Therefore, the first digital signal input to the logic operation unit 22 is a high-level signal “1”. The first digital signal is reversely input to the logic operation unit 22 as a “0” signal. Meanwhile, the second digital input from the protection activation signal source 23 is normally a high-level signal “1” input to the second input terminal of the logic operation unit 22. By the NAND operation, a “1” signal is output, such that the voltage protection unit 24 will not be activated.

When the operation voltage of the coil driving device 1 is equal to or higher than the predetermined value, the switch 211, that is, the transistor Q1, of activation control unit 21 of the high-voltage protection device 2 is switched off Therefore, the first digital signal input to the logic operation unit 22 becomes “0”. Through reverse input, a “1” signal is input to the logic operation unit 22. By the NAND gate operation performed on the first “1” signal and the second “1” signal, the output of the logic operation unit 22 is “0”. Thereby, the third switch 241, that is, the transistor Q2, of the voltage protection unit 24 is activated, and the second highest power source is operating to output a high-level digital signal to activate the first switch 11 of the coil driving device 1. Therefore, the coil driving device 1 is conducted with the lowest voltage source, and the operation voltage returns to normal value or smaller than the predetermined value.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A high-voltage protection device applied to a coil driving device of a DC fan or motor, the coil driving device being connected to the high-voltage protection device, and the high-voltage protection device comprising:
an activation control unit connected to the coil driving device;
a logic operation unit connected to the activation control unit, the logic operation unit having a first input terminal connected to the activation control unit to obtain a first digital signal therefrom and a second input terminal;
a protection activation signal source for providing a second digital signal to the second input terminal;
a high-voltage protection unit connected to an output terminal of the logic operation unit and the coil driving device; wherein
when an operation voltage of the coil driving device is higher than a predetermined value, the activation control unit inputs the first digital signal to the first terminal, and the logic operation unit performs calculation on the first and the second digital signals to output a protection activation signal for activating the high-voltage protection device.

2. The device of claim 1, wherein the activation control unit comprises at least a second switch having a second terminal connected to the coil driving device and a second terminal connected to a current source to form an output terminal.

3. The device of claim 2, wherein the second switch includes a transistor.

4. The device of claim 2, wherein the predetermined value includes a voltage required for switch operation of the second switch.

5. The device of claim 1, wherein the logic operation unit includes a logic operation device to inversely generate an output signal based on voltage levels of the first and second digital signals.

6. The device of claim 1, wherein the voltage protection unit includes at least a third switch and a resistor, the third switch includes a first terminal connected to the output terminal of the logic operation unit and a second terminal connected to the resistor to form an output terminal connected to the coil driving device.
